(19) United States
(12) Patent Application Publication
(10) Pub. No.: US 2016/0228861 A1
(43) Pub. Date: Aug. 11, 2016

(54) Twisted Polylobed Extrudates and Process for Their Manufacture

(71) Applicant: ExxonMobil Chemical Patents Inc.

(72) Inventors: Wenyih F. Lai, Bridgewater, NJ (US); Jean W. Beeckman, Columbia, MD (US); Theodore E. Datz, Easton, PA (US); Natalie A. Fassbender, Nazareth, PA (US)

(21) Appl. No.: 14/978,095

(22) Filed: Dec. 22, 2015

Related U.S. Application Data
(60) Provisional application No. 62/110,833, filed on Feb. 2, 2015.

(30) Foreign Application Priority Data
Mar. 27, 2015 (EP) 15161366.8

(51) Int. Cl. B01J 29/70; B01J 35/02; B01J 20/30; B01J 20/18; B01J 20/08; B01J 20/28; B01J 21/04; B01J 37/00

(52) U.S. Cl. CPC B01J 29/703; B01J 21/04; B01J 35/02; B01J 37/0009; B01J 20/18; B01J 20/08; B01J 20/28042; B01J 20/3021; B01J 20/3007

(57) ABSTRACT

The invention relates to moderately twisted polylobed extrudates having improved crush strength. The moderately twisted polylobed extrudates have an oblong shape and a cross section comprising a plurality of lobes, which lobes extend along and are twisted around a longitudinal axis of the extrudate and wherein the twist has a pitch from about 0.5 turns/inch (0.5 turns per 2.54 cm) to about 2 turns/inch (2 turns per 2.54 cm). Further the invention relates to a method for manufacturing such moderately twisted polylobed extrudates and their use as catalysts or adsorbents.

### CROSS REFERENCE TO RELATED APPLICATIONS

This application claims the benefits of and priorities to U.S. Ser. No. 62/110,833, filed Feb. 2, 2015, and EP 15161366.8, filed Mar. 27, 2015, the disclosures of which are incorporated by reference in their entireties.

### TECHNICAL FIELD

The invention relates to twisted polylobed extrudates, their method of manufacturing and their use as catalysts. In particular the invention relates to polylobed extrudates which are moderately twisted around their longitudinal axis.

### BACKGROUND

Many industrial processes employ catalysts comprising a catalytically active material supported on a shaped body (particle, extrudate) or bound in a shaped body. Examples of such catalysts include supported metals, supported metal complexes, supported organometallics, bound zeolites and bound zeolite-type materials. The shaped bodies used in such catalysts are typically made of refractory inorganic oxides by forming a mixture of one or several sources of the inorganic oxide in a suitable vehicle, such as water and/or an organic solvent. The mixture is then formed into various shapes, generally by extrusion, and subsequently dried and calcined to produce the final shaped body. The shaped particles/bodies are usually referred to as extrudates.

In order to be used as catalyst, the finished extrudate bodies (after calcination) must have appropriate surface properties, sizes, shapes and porosities to carry the desired amounts of active materials. The shaped bodies must also be strong enough to enable catalyst handling, especially during reactor loading and unloading, and to sustain the conditions experienced during the intended catalytic use. They must also have appropriate porosities and shapes to avoid high pressure drops across the reactor and allow the desired catalytic reactions to take place.

Therefore mechanical and physical properties of extrudates, such as crush strength, surface area, density and the aspect ratio of the extrudates are critical for manufacturing high quality commercial catalysts.

Extrudates with low aspect ratio and/or low crush strength may cause an excessive pressure drop through the reactor bed. When using a process employing a fixed bed of catalyst particles, a major consideration in the design of the process is the pressure drop through the catalyst bed, which should be as low as possible.

Conventional approaches for improving the aspect ratio or crush strength include the addition of additives (such as acid, base or polymers), varying extrusion solids percentage, varying mulling procedures and/or reinforcements of the extrudates by e.g. adding metal oxide fiber.

Polylobed-shaped extrudates are commercially available and used in fixed bed processes. They typically include trilobe and quadrulobe cross section shapes. Polylobed extrudates serve as alternatives to the conventional cylindrical shape, having a higher surface-to-volume ratio, thereby providing a more active catalyst.

U.S. Pat. No. 4,673,664 discloses catalyst particles and catalyst support particles that are helical polylobed extrudates having the shape of three or four strands wound helically about the axis of extrusion along the length of the particles. The helical shape of the catalyst particle is found to reduce pressure drop across fixed bed reactors. However, it was found that a helical polylobed particle having the same diameter and the same cross section as a straight polylobed particle has considerably less crush strength than the straight lobed polylobed particle.

EP 0510770 discloses an increase in efficiency of helical lobed catalyst particles in fixed catalyst beds employed in Fischer-Tropsch synthesis, for a given volume of fixed bed, compared with the equivalent straight lobed catalyst particles.

Therefore, there is still a need to find new types of extrudates with an improved mechanical strength, being more resistant to breakage and/or having improved crush strength, while maintaining a high surface-to-volume ratio and reduced pressure drop in reactors.

### SUMMARY

The purpose and the advantages of the present invention will be set forth in and apparent from the description that follows, as well as will be learned by practice of the invention. Additional advantages if the invention will be realized and attained by the methods and systems particularly pointed out in the written description and claims hereof, as well as from the appended drawings.

The present invention provides a twisted polylobed extrudate having an oblong shape and a cross section comprising a plurality of lobes, which lobes extend along and are twisted around a longitudinal axis of the extrudate and wherein the twist has a pitch from about 0.5 turns/inch (0.5 turns per 2.54 cm) to about 2 turns/inch (2 turns per 2.54 cm). Preferably, the pitch is from at least 0.5 turns/inch (0.5 turns per 2.54 cm) to no more than 2 turns/inch (2 turns per 2.54 cm), more preferably less than 2 turns/inch (2 turns per 2.54 cm). Alternatively, the pitch is from at least 0.7 turns/inch (0.7 turns per 2.54 cm) to no more than 1.6 turns/inch (1.6 turns per 2.54 cm). This means that the polylobed extrudates are moderately twisted.

The moderately twisted polylobed extrudates of the invention are more resistant to breakage and have an improved crush strength compared with highly twisted polylobed extrudates. Also, the moderately twisted polylobed extrudates of the invention preserve the advantages of twisted polylobed extrudates with respect to straight polylobed extrudates, such as a higher loading density.

In addition to the advantages mentioned above, the moderately twisted polylobed extrudates of the invention have a higher aspect ratio (ratio of the longest dimension to the shortest dimension) compared with the highly twisted polylobed extrudates. In particular, the length of the freshly prepared (green) moderately twisted extrudates is greater than about 2 inch (5.08 cm), more preferably greater than about 3 inch (7.62 cm) for a diameter from about 1/30 inch (0.8 mm) to about ⅛ inch (3.2 mm). The high aspect ratio leads to an improved catalyst characterized by a low pressured drop across the reactor.

In another aspect, the present invention provides a method for manufacturing twisted polylobed extrudates comprising: (a) mulling an extrusion mixture with a liquid to form a paste; (b) adding the mulled extrusion mixture to an extruder, the extruder having a die plate comprising one or more dies, each die having a plurality of apertures; (c) extruding the paste through the plurality of apertures to form twisted polylobed extrudates; wherein the apertures are configured to form extrudates having an oblong shape and a cross section comprising a plurality of lobes, which lobes extend along and are twisted around a longitudinal axis of the extrudate and wherein the twist has a pitch from about 0.5 turns/inch (0.5 turns per 2.54 cm) to about 2 turns/inch (2 turns per 2.54 cm). Preferably, the twist has a pitch from at least 0.5 turns/inch (0.5 turns per 2.54 cm) to no more than 2 turns/inch (2 turns per 2.54 cm), more preferably less than 2 turns/inch (2 turns per 2.54 cm). Alternatively, the pitch is from at least 0.7 turns/inch (0.7 turns per 2.54 cm) to no more than 1.6 turns/inch (1.6 turns per 2.54 cm).

The twisted polylobed extrudates formed at step (c) have a length greater than about 2 inch (5.08 cm), preferably greater than about 3 inch (7.62 cm). The diameter of the apertures is from about 1/30 inch (0.8 mm) to about ⅛ inch (3.2 mm). Advantageously, the aspect ratio of the green extrudates formed at step (c) is higher than the aspect ratio of highly twisted polylobed extrudates with the same diameter.

Preferably, the moderately twisted polylobed extrudates of the invention comprise at least one of a zeolite or a mesoporous material, a binder and, optionally, a promoter.

In another aspect, the invention relates to the use of the moderately twisted polylobed extrudate as a catalyst.

In yet another aspect, the invention relates to the use of the moderately twisted polylobed extrudate as an adsorbent.

These and other features of the present invention will become apparent from the following detailed description of preferred embodiments which, taken in conjunction with the accompanying drawings, illustrate by way of example the principles of the present invention.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIGS. 1 A and 1B show a twisted extrusion die of Type A suitable for the manufacture of twisted polylobed extrudates according to embodiments of the invention, with a twist having a pitch of about 1 turn per inch (1 turn per 2.54 cm).

FIGS. 2A and 2B show a twisted extrusion die of Type B suitable for the manufacture of twisted polylobed extrudates according to embodiments of the invention, with a twist having a pitch of about 1 turn per inch (1 turns per 2.54 cm).

FIGS. 3A, 3B, and 3C show moderately twisted polylobed extrudates of the invention fabricated with the twisted die of Type A.

FIG. 4 shows straight polylobed extrudates (left) and moderately twisted polylobed extrudates of the invention (right).

### DETAILED DESCRIPTION

In the following detailed description section, the specific embodiments of the present invention are described in connection with preferred embodiments. However, to the extent that the following description is specific to a particular embodiment or a particular use of the present invention, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The invention relates to a twisted polylobed extrudate having an oblong shape and a cross section comprising a plurality of lobes, which lobes extend along and are twisted (rotated) around a longitudinal axis of the extrudate, wherein the twisted lobes have a pitch from about 0.5 turns/inch (0.5 turns per 2.54 cm) to about 2 turns/inch (2 turns per 2.54 cm).

The term twisted polylobed extrudate as used herein is a reference to a particle/body having an oblong shape and a cross section comprising a plurality of lobes, which lobes extend along and are twisted (rotated, turned) around a longitudinal axis of the particle. Preferably, the cross section comprises three (trilobed, T) or four lobes (quadrulobed, Q) formed by the intersection of respectively three or four ellipses.

The pitch is a measure of the twist (rotation) around the longitudinal axis of the extrudate and it is given by the number of turns per unit length. The higher the number of turns, the more twisted (or closely packed) is the structure.

The extrudates are in the form of elongated bodies/particles having a substantially constant cross section which corresponds to the aperture of the extrusion die used to form the extrudates. The shaped bodies may be characterized by an average length, an average diameter and an average aspect ratio. Unless otherwise indicated, the length of an extrudate corresponds to the extruded length of said extrudates (or length of the freshly prepared green extrudates), the diameter of an extrudate corresponds to the outside diameter of said extrudate cross section, i.e. the diameter of the smallest circle circumscribing the cross section, and the aspect ratio of an extrudate corresponds to the ratio of its length on its diameter.

Thus, for example, for a cylindrical shape, the diameter of the extrudate corresponds to the diameter of the disc cross section. For a quadrulobed extrudate, the diameter is the highest dimension of the quadrulobed section, i.e. the longest distance, in a straight line between two points on the quadrulobed cross section and its center. The diameter of an extrudate is substantially constant, as the cross section of the extrudate is dictated by the size of the hole in the extrusion die.

The average length, average diameter, and average aspect ratio of the extrudates of the present invention were determined by optical scanner imaging using ALIAS Image Analysis System (Cascade Data System). The sample size is typically of 150 to 250 particles. The average length and average diameter are the numerical averages (arithmetic means) of the measured individual lengths and diameters while the aspect ratio is the fraction of said average length on said average diameter. Further, the average length, the average diameter and the average aspect ratio will be referred as the length, the diameter and, respectively, the aspect ratio (L/D) of the extrudates.

Preferably, the twisted polylobed extrudates of the invention have a pitch of at least 0.5 turns/inch (0.5 turns per 2.54 cm) and less than 2 turns/inch (2 turns per 2.54 cm), leading to improved crush strength and high aspect ratios.

In particular examples, the twisted polylobed extrudates of the invention have a pitch of about 1 turn/inch (1 turn per 2.54 cm), for example about 1.1 turns/inch (1.1 turns/2.54 cm).

The twisted polylobed extrudates of the invention having a pitch from 0.5 turns/inch (0.5 turns per 2.54 cm) to 2 turns/inch (2 turns per 2.54 cm) are referred herein as moderately twisted polylobed extrudates. In contrast therewith, polylobed extrudates having a twist of 4 turns/inch (4 turns per 2.54 cm) or more are referred herein as highly twisted polylobed extrudates.

The extruded length of the moderately twisted polylobed extrudates is longer than the length of the highly twisted extrudates with the same diameters. Longer extrudates make improved catalysts, characterized by a lower pressure drop across the reactor.

In different embodiments the moderately twisted extrudates of the invention have a length greater than about 2 inch (5.08 cm) and a diameter from about 1/30 inch (0.8 mm) to about ⅛ inch (3.2 mm).

In preferred embodiments, the moderately twisted extrudates of the invention have a length greater than about 3 inch (7.62 cm) and a diameter ranging from about 1/30 inch (0.8 mm) to about ⅛ inch (3.2 mm).

In particular examples, the twisted polylobed extrudates of the invention have a length from about 3 inch (7.62 cm) to about 6 inch (15.24 cm).

In embodiments of the invention the diameter of the twisted polylobed extrudates ranges from about 1/30 inch (0.8 mm) to about ⅛ inch (3.2 mm). In particular embodiments of the invention, the diameter of the twisted polylobed extrudates is about 1/16 inch (1.6 mm). In other particular embodiments of the invention, the diameter of the twisted polylobed extrudates is about 1/20 inch (1.3 mm).

In another aspect, the invention relates to a catalyst shaped in the form of a twisted polylobed extrudate having a cross section comprising a plurality of lobes, which lobes extend along and are twisted around a longitudinal axis of the extrudate and wherein the twist has a pitch from about 0.5 turns/inch (0.5 turns per 2.54 cm) to about 2 turns/inch (2 turns per 2.54 cm), preferably the pitch is from at least 0.5 turns/inch (0.5 turns per 2.54 cm) to no more than 2 turns/inch (2 turns per 2.54 cm), more preferably less than 2 turns/inch (2 turns per 2.54 cm). Alternatively, the pitch is from at least 0.7 turns/inch (0.7 turns per 2.54 cm) to no more than 1.6 turns/inch (1.6 turns per 2.54 cm).

The moderately twisted polylobed extrudates of the invention are more resistant to breakage than the straight polylobed extrudates. The resistance to breakage has been determined by measuring the aspect ratio (L/D) of the moderately twisted extrudates after performing 3 times and, respectively, 6 times a drop test from 6 ft (1.8 m) and comparing said aspect ratio with the aspect ratio of the straight extrudates having the same diameter subjected to the same test, under the same conditions. The improvement is shown in Table 1 and discussed in further details in the examples section.

A known drawback of the highly twisted polylobed extrudates is the considerably lower crush strength compared with straight polylobed extrudates having the same diameter and the same cross section. Contrary to what would be expected by a skilled person, the moderately twisted shaped bodies of the invention have significantly improved crush strength over the straight polylobed extrudates, as shown by the results of the bulk crush strength analysis in Table 2, discussed in further details in the examples section.

In addition, the moderately twisted quadrulobed extrudates of the invention are characterized by a higher loading density compared with the straight quadrulobed extrudates, as explained in further details in the examples section, in relation to the results in Table 1.

In embodiments of the invention, the moderately twisted polylobed extrudates comprise at least one of a zeolite or a mesoporous material, a binder and, optionally, a promoter.

The choice of binder depends on various factors, such as, for example, the intended catalytic use, the type of active material used, the required catalyst strength and the required diffusivity across catalyst extrudates. The binder is preferably a refractory metal oxide, more preferably a porous carrier. The porous carrier may be selected from any of the suitable refractory metal oxides or silicates or combinations thereof known in the art. Particular examples of preferred porous carriers include silica, alumina, titania, zirconia, ceria, gallia and mixtures thereof.

For certain catalytic processes, it is desirable to use amorphous or crystalline silica or mixtures of amorphous and crystalline silica as a catalyst and/or binder. Suitable forms of amorphous silica include silica powders or silica sols, which are stable colloidal dispersions of amorphous silica particles in an aqueous or organic liquid medium. Suitable forms of crystalline silica include microporous and mesoporous molecular sieves containing SiO₄ tetrahedra, such as crystalline silicates, metallosilicates (especially aluminosilicates), silicoaluminophosphates and transition metal ion containing zeolites. Non-limiting examples of such zeolitic materials include ZSM-5, ZSM-11, ZSM-12, ZSM-22, ZSM-23, ZSM-48, ZSM-57, MCM-22, MCM-49, MCM-56, MCM-41, M-41S, MCM-48, mordenite, chabazite, faujasite, zeolite Y, zeolite beta, ferrierite, SAPO-5, SAPO-11, SAPO-18, SAPO-34, SAPO-56, ITQ-1, ITQ-2, ITQ-3, ITQ-13, ITQ-21, ITQ-22, ITQ-24, metal-containing forms thereof, intergrown crystalline forms thereof and mixtures thereof. Non-limiting examples of such materials include aluminosilicates or germanoaluminosilicates having a silica/alumina molar ratio of at least 10.

For certain applications, it may also be useful to include a promoter in the extrudates of the present invention. The promoter can comprise a metal precursor of a catalytically active metal. Non-limiting examples of catalytically active metals include platinum, palladium, ruthenium, iron, cobalt and nickel. The promoters might also be present as metals or as metal oxides.

In another aspect, the present invention relates to the use of the moderately twisted polylobed extrudates according to the different embodiments described herein as catalysts in catalytic processes. When used as catalysts, comparative tests show that the moderately twisted polylobed extrudates exhibit similar conversion and selectivity compared to straight extrudates.

Catalysts in the shape of the moderately twisted extrudates of the invention can be used in a wide variety of catalytic processes, especially those that require rapid diffusion of reagents and products throughout the catalyst. Non-limiting examples of such catalytic processes include reactions using hydrogen, such as hydrogenation, desulfurization, hydrofining, hydrofinishing or hydrocracking; polymerization reactions, such as supported Ziegler-Natta or metallocene polymerization reactions; catalytic cracking; catalytic dewaxing; olefin oligomerization; olefin isomerization; alkylation, for example aromatic alkylation, reformate alkylation, phenol alkylation; the conversion of light olefins to gasoline, distillate and lube range hydrocarbons; the conversion of oxygenates to hydrocarbons.

In yet another aspect the present invention relates to the use of the moderately twisted polylobed extrudates according to the different embodiments described herein as adsorbents.

In another aspect, the present invention relates to a method for manufacturing twisted polylobed extrudates comprising: (a) mulling an extrusion mixture with a liquid to form an extrusion paste; (b) adding the mulled extrusion mixture (extrusion paste) to an extruder, the extruder having a die plate comprising one or more dies, each die having a plurality of apertures; (c) extruding the paste through the plurality of apertures to form the twisted polylobed extrudates; wherein the apertures are configured to form extrudates having an oblong shape and a cross section comprising a plurality of lobes, which lobes extend along and are twisted around a longitudinal axis of the extrudate and wherein the twisted lobes have a pitch from about 0.5 turns/inch (0.5 turns per 2.54 cm) to about 2 turns/inch (2 turns per 2.54 cm).

The extrusion mixture used for preparing the moderately twisted polylobed extrudate of the invention comprises at least one of a zeolite or a mesoporous material, a binder and, optionally, a promoter. The extrusion mixture may further comprise an additive such as an extrusion aid, such as a polymeric organic extrusion aid. Non limiting examples of suitable polymeric organic extrusion aids include polyvinyl alcohols, cellulose, and cellulose ethers such as methylcellulose and hydroxypropyl methyl cellulose polymers.

Preferably, in the method of the invention the twisted polylobes have a pitch from at least 0.5 turns/inch (0.5 turns per 2.54 cm) to no more than 2 turns/inch, more preferably less than 2 turns/inch (2 turns per 2.54 cm). Alternatively, the pitch is from at least 0.7 turns/inch (0.7 turns per 2.54 cm) to no more than 1.6 turns/inch (1.6 turns per 2.54 cm). In particular examples the twist has a pitch of about 1 turn/inch (1 turn per 2.54 cm), for example about 1.1 turns/inch (1.1 turns per 2.54 cm).

Particle shaping is generally performed by extrusion. Extrusion apparatuses suitable for making rod-, cylindrical or prisms-shaped particles typically comprise a hopper for the introduction of the mixture (paste) being shaped, a de-airing chamber, and either a screw-type or a plunger-type transport barrel in which pressure is generated for passage of the mixture through a die of the desired geometry. The mixture is extruded onto a carrier belt and passed through driers to relax the strain remaining after extrusion. The driers remove most of the water from the extruded product, but typically do not remove any organic material that might be present in the extrudates. Drying is usually performed at a temperature less than 200° C., such as between 100° C. and 150° C., typically between 120° C. and 140° C. for a period of at least 10 minutes, such as from 10 minutes to several hours. The strands obtained after drying are broken up in smaller pieces to form cylinders or prisms. The cylinders or prisms are then sieved and broken up further to the required size range.

After shaping and drying at a temperature of less than 200° C., the shaped extrudates are usually referred to as “green” extrudates or green catalyst. The green extrudates still contain any polymeric extrusion aid that may have been used and typically have crush strengths that are too low for use in catalytic processes. Heat treatments are thus necessary to harden the extrudates, and remove any organic material that may be present in the catalyst and that could interfere during use of the shaped bodies. In the process of the invention, such heat treatment is performed by calcination, i.e. by heating at temperatures ranging from about 300° C. to about 800° C., for example from about 500° C. to about 750° C. If organic materials are present in the green shaped body, it is preferred that calcination take place in the presence of at least 2 vol. % air, preferably at least 5 vol. % air. In addition, it may be desirable to perform the calcination in the presence of steam, such as a mixture of steam and air, in order to obtain shaped bodies having a desired pore size range. Suitable calcination atmospheres contain 10-20 vol. % steam and 90-80 vol. % air; for example 2-10 vol. % air and 98-90 vol. % steam. By varying the calcination temperature and composition of the calcination atmosphere, shaped bodies with different pore sizes can be obtained.

Calcination can be conducted for variable amounts of time, depending on the calcination temperature and the composition of the calcination atmosphere. The duration should be sufficient to allow removal of any organic material present in the extrudates, and should also be sufficient to harden the extrudates to the desired level. However, calcination should not be carried out too long to avoid shaped body degradation. Typically, the desired results are achieved by applying the calcination conditions for a time of from about 1 hour to about 6 hours, such as from about 2 hours to about 4 hours.

The invention will now be more particularly described with reference to the following non-limiting Examples.

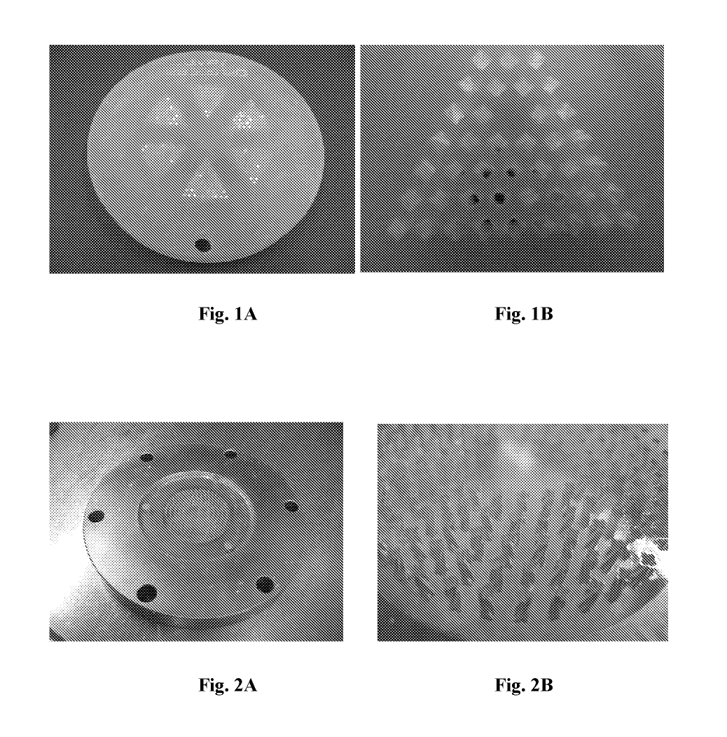

Two types of twisted extrusion dies shown in FIGS. 1A and 1B and FIGS. 2A and 2B were designed to have a pitch of 1 turn/inch (1 turn per 2.54 cm). Quadrulobed (Q) extrudates with 1/16″ (1.6 mm) and, respectively, 1/20″ (1.3 mm) diameter were produced using a regular straight die and the twisted die shown in FIGS. 1A and 1B, for comparison.

The resulting green twisted extrudates showed unique properties of smooth surface and long length of 3 inch (7.6 cm) up to 6 inch (15.2 cm).

### Examples 1A and 2A

### Regular (Straight) Quadrulobed Die

Regular (straight) extrudates for use as catalysts were prepared starting from 65 parts of ZSM-48 crystals and 35 parts of Versal 300 pseudoboehmite alumina (basis: calcined 538° C.) which were mixed in a Simpson muller. Sufficient water was added to produce an extrudable paste on a 2 inch (5.08 mm) Bonnot extruder.

The mix of ZSM-48, pseudoboehmite alumina and water containing paste was extruded using 1/16″ (1.6 mm) straight Q-die (Example 1A) and 1/20″ (1.3 mm) straight Q-die (Example 2A) and dried in a hotpack oven at 121° C. overnight.

Regular dried extrudates were calcined in nitrogen at 538° C. to remove the organic template. The N₂ calcined extrudates were humidified with moisture saturated air and exchanged with 1 N ammonium nitrate to remove sodium (<500 ppm Na). After the ammonium nitrate treatment, the extrudates were washed with deionized water to remove residual nitrate ions prior to drying. The ammonium exchanged extrudates were dried at 121° C. overnight and calcined in air at 538° C. Properties of the resulting catalyst are shown in Table 1.

### Examples 1B and 2B

### Twisted Quadrulobed Die

Moderately twisted extrudates for use as catalysts were prepared starting from 65 parts of ZSM-48 crystals and 35 parts of Versal 300 pseudoboehmite alumina (basis: calcined 538° C.) which were mixed in a Simpson muller. Sufficient water was added to produce an extrudable paste on a 2 inch (5.08 mm) Bonnot extruder.

The mix of ZSM-48, pseudoboehmite alumina and water containing paste was extruded using 1/16″ (1.6 mm) twisted Q-die (Example 1B) and 1/20″ (1.3 mm) twisted Q-die (Example 2B) and dried in a hotpack oven at 121° C. overnight.

Moderately twisted dried extrudates were calcined in nitrogen at 538° C. to remove the organic template. The N₂ calcined extrudates were humidified with moisture saturated air and exchanged with 1 N ammonium nitrate to remove sodium (<500 ppm Na). After the ammonium nitrate treatment, the extrudates were washed with deionized water to remove residual nitrate ions prior to drying. The ammonium exchanged extrudates were dried at 121° C. overnight and calcined in air at 538° C.

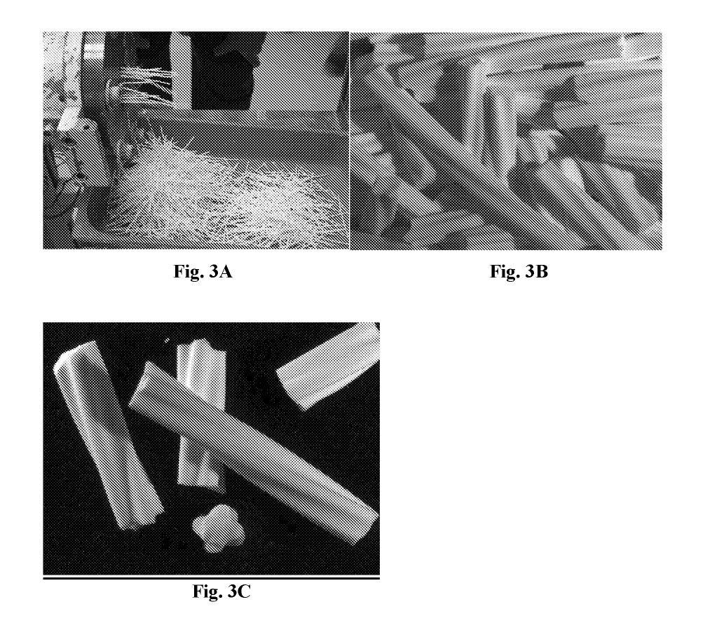

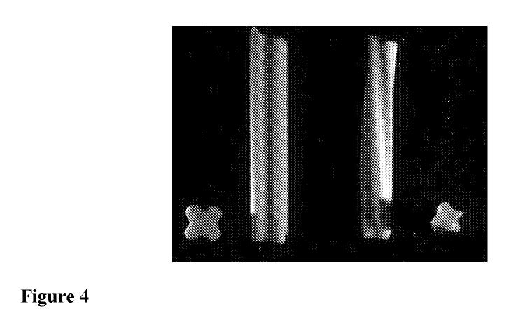

Pictures of twisted extrudates with a pitch of 1 turn/inch (1 turn per 2.54 cm) are shown in FIGS. 3A, 3B and 3C. A comparison between straight (left) and twisted extrudates (right) is shown in FIG. 4.

Properties of the resulting catalyst are shown in Table 1. The samples prepared as described in the Examples above were characterized using different characterization methods.

BET surface area (total, micropores and mesopores) has been determined by adsorption-desorption of nitrogen, using a Micromeritics Tristar V6.05 instrument.

Pore volume (Hg), and total pore area (SA) were determined by mercury (Hg) intrusion porosimetry, according to the ASTM D 4284-03 method, assuming a contact angle of 130° for mercury on silica, using a Micrometitics AutoPore IV 9500 instrument.

The alpha value reflects the relative activity of the catalyst with respect to a high activity silica-alumina cracking catalyst. Alpha values were determined by measuring n-hexane conversion at about 426° C. (800° F.). Conversion is varied by varying the space velocity such that a conversion level of 10 to 60 percent of n-hexane is obtained and converted to a rate constant per unit volume of catalyst and compared with that of silica-alumina catalyst which is normalized to a reference activity of 538° C. (1000° F.). Catalytic activity of the catalyst is expressed as a multiple of this standard, i.e. the silica-alumina standard. The silica-alumina reference catalyst contains about 10 wt % Al₂O₃ and the remainder SiO₂. This method of determining alpha, modified as described above, is more fully described in the U.S. Pat. No. 4,016,218.

An increase of about 9% and 18% has been observed in the loading density for the moderately twisted extrudates having a diameter of 1/16″ (1.6 mm) and 1/20″ (1.3 mm), respectively, when compared with the regular extrudates of the same diameter, while no significant differences were measured in alpha value or in surface area.

The moderately twisted extrudates are more resistant to breakage than the straight extrudates. The results of the drop test illustrated in the last two rows of Table 1 show that the aspect ratio L/D of the moderately twisted extrudates (Examples 1B and 2B) after performing the drop test is higher than the aspect ratio of the corresponding straight extrudates (Examples 1A and 2A). In particular, after performing the drop test 6 times, the aspect ratio of the moderately twisted extrudates are 2.53 (Example 1B) and 2.93 (Example 2B) compared, respectively, with 1.55 (Example 1A) and 2.69 (Example 2A) for the straight extrudates.

A significant improvement was observed for the moderately twisted extrudates having a diameter of 1/16″ (1.6 mm), whose aspect ratio after performing the drop-test 3 times from 6 ft (1.8 m) was about 50% higher than the aspect ratio of the corresponding straight extrudates subjected to the same test. After performing 6 times the drop-test from 6 ft (1.8 m), the improvement was even more significant (about 60%).

TABLE 1
Properties of the moderately twisted quadrulobed extrudates (T) according
to the invention compared with the regular (straight) quadrulobed
extrudates (R).

| | Sample (example) | | | |
|---|---|---|---|---|
| | 1A, | 1B, | 2A, | 2B, |
| | 1/16″ R | 1/16″ T | 1/20″ R | 1/20″ T |
| Alpha | 77 | 57 | 70 | 76 |
| BET, (m²/g) | 279/ | 296/ | 292/ | 288/ |
| (total/ | 71 + 208 | 77 + 219 | 75 + 217 | 75 + 213 |
| micro + meso) | | | | |
| Particles density by | 0.864 | 0.913 | 0.922 | 0.918 |
| Hg | | | | |
| Pore volume (Hg) | 0.708 | 0.653 | 0.633 | 0.641 |
| (mg/l) | | | | |
| Surface area (Hg) | 227 | 236 | 222 | 232 |
| (m²/g) | | | | |
| N-hexane | 40.6 | 40.9 | 41.0 | 41.6 |
| (mg/g) | | | | |
| Loading density | 0.467 | 0.511 | 0.485 | 0.576 |
| (g/cm³) | | | | |
| Drop test | 1.78 | 2.73 | 3.23 | 3.22 |
| 3 × 6 ft | | | | |
| L/D | | | | |
| Drop test | 1.55 | 2.53 | 2.69 | 2.93 |
| 6 × 6 ft | | | | |
| L/D | | | | |

### Bulk Crush Strength Test

This method describes the determination of bulk crush strength of a bed of particles. The method provides information concerning the ability of these solids to maintain physical integrity after exposure to an applied pressure. In addition, it can offer a relative ranking comparison for the assessment of pressure drop effects in fixed bed applications. ASTM D7084-04 standard test method for determination of bulk crush strength of catalysts and catalysts carriers was followed.

The test was performed using a Bulk Crush Testing apparatus, a set of standard sieves (U.S. Sieve or Tyler equivalent), a balance with a sensitivity of 0.01 g, a fixed straight edge for proper loading of sample cup and a 6-inch carpenter level to ensure position of the sample cup. The bulk crush apparatus was placed on a level surface, such as a lab bench. The metal housing was leveled properly before making any measurements. Compressed air was piped to the device using a 2-stage step-down regulation system. The maximum pressure allowed in the system was 100 psi (689.4 kPa). The force gauge and the analytical balance are pre-calibrated to ensure accuracy before using. The sample was well mixed and prepared using cone and quartering, splitting and/or riffling to obtain a sample that is representative of the total amount. Some spent or regenerated samples may exhibit length distributions that are skewed. In such cases, the sample was first homogenized and a representative sample obtained as described above.

After obtaining a representative sample, the tare weight of the sample cup was determined. Then the sample cup was filled with a catalyst sample, levelled using a metal straight edge and weighted to obtain the dry weight (DW) of the sample being evaluated. Then a load block was placed on top of the catalyst bed in the cup and the cup with the catalyst was placed in a holder on top of a piston. A ball bearing was placed in the center of the load block and a lockarm was placed over the ball bearing and adjusted until horizontally level before locking it firmly in place. Using a pressure regulator and a needle valve, pressure was applied to the sample. Based on the measurements at the applied pressures a curve was generated that allows the extrapolation of the pressure value at which 3% fines are generated. The hold time was 60 seconds before the bleed valve was opened and the pressure released from the sample cup load plate.

After completion of the crush test, the sample cup was removed from the piston and the content of the cup was charged to a series of standard U.S. Sieve or Tyler screens. Screen Mesh Size of 10, 12, 14, 16, 18 and 20 were used for the analysis. Screen sizes can be adjusted based on the catalysts under evaluation. Generally, fines are described as any particles less than ⅓ of the diameter of the particle. The smallest screen size may need to be adjusted to fit the catalyst being tested. Sieving was performed for 30 seconds.

The fines collected as described above were weighted (PW). Then the percentage of fines F (wt %) generated for each applied pressure was calculated according to the formula:

F=(PW/DW)×100

TABLE 2
Bulk Crush Strength Analysis: quadrulobed twisted extrudates vs.
quadrulobed straight extrudates:

| | Air pressure | wt | Fines |
|---|---|---|---|
| | (psi) | % of fines | reduction (%) |
| 1/16″ Q Regular | 20 | 4.5 | — |
| straight extrudates | 30 | 12 | — |
| 1/16″ Q Twisted extrudates | 20 | 3.4 | 24 |
| | 30 | 6.6 | 45 |
| 1/20″ Q Regular | 20 | 2.9 | — |
| straight extrudates | 30 | 8.6 | — |
| 1/20″ Q Twisted extrudates | 20 | 2.1 | 27 |
| | 30 | 5.9 | 31 |

Table 2 shows the results of the bulk crush tests on two twisted quadrulobe extrudates having a diameter of 1/16″ (1.6 mm) and 1/20″ (1.3 mm) and two straight extrudates having the same diameter. Two pressures were applied: 20 psi (137.8 kPa) and 30 psi (206.8 kPa). At both applied pressures, the twisted extrudates formed a lower percentage of fines (wt %) compared with the straight ones. Reductions of 24% and 45% in the percentage of fines were measured at 20 psi and 30 psi, respectively, for the 1/16″ (1.6 mm) twisted quadrulobed extrudates when compared with the corresponding straight quadrulobe extrudates. For the 1/20″ (1.3 mm) twisted quadrulobed extrudates reductions of 27% and 31% were measured at 20 psi and 30 psi, respectively. This proves a clear increase in crush strength of the moderately twisted extrudates compared with the straight ones.

It will be apparent to those skilled in the art that various modifications and/or variations may be made without departing from the scope of the present invention. It is intended that all matter contained in the accompanying specification shall be interpreted as illustrative only and not in a limiting sense. While the present invention has been described in the context of moderately twisted shaped bodies as catalysts, the use is not intended to be so limited; rather it is contemplated that the present invention is suitable for other uses of the moderately twisted shaped bodies such as e.g. as adsorbents in adsorption processes.

1. A twisted polylobed extrudate having an oblong shape and a cross section comprising a plurality of lobes, which lobes extend along and are twisted around a longitudinal axis of the extrudate and wherein the twisted lobes have a pitch from about 0.5 turns/inch (0.5 turns per 2.54 cm) to about 2 turns/inch (2 turns per 2.54 cm).

2. The twisted polylobed extrudate of claim 1, wherein the pitch is at least 0.5 turns/inch (0.5 turns per 2.54 cm) and less than about 2 turns/inch (2 turns per 2.54 cm).

3. The twisted polylobed extrudate of claim 1, wherein the pitch is at least 0.7 turns/inch (0.7 turns per 2.54 cm) and no more than 1.6 turns/inch (1.6 turns per 2.54 cm).

4. The twisted polylobed extrudate of claim 1, wherein an extruded length of the extrudate is greater than about 2 inch (5.08 cm).

5. The twisted polylobed extrudate of claim 1, wherein a diameter of the extrudate is from about 1/30 inch (0.8 mm) to about ⅛ inch (3.2 mm).

6. The twisted polylobed extrudate of claim 1, wherein the diameter of the extrudate is from about 1/20 inch (1.3 mm) to about 1/16 inch (1.6 mm).

7. The twisted polylobed extrudate of claim 1, wherein the cross section comprises three lobes.

8. The twisted polylobed extrudate of claim 1, wherein the cross section comprises four lobes.

9. The twisted polylobed extrudate of claim 1, wherein the extrudate comprises at least one of a zeolite or a mesoporous material, a binder and, optionally, a promoter.

10. A catalyst shaped as a twisted polylobed extrudate according to claim 1.

11. A method for manufacturing twisted polylobed extrudates comprising:
a. mulling an extrusion mixture with a liquid to form a paste;
b. adding the mulled extrusion mixture (paste) to an extruder, the extruder having a die plate comprising one or more dies, each die having a plurality of apertures;
c. extruding the paste through the plurality of apertures to form twisted polylobed extrudates,
wherein the apertures are configured to form extrudates having an oblong shape and a cross section comprising a plurality of lobes, which lobes extend along and are twisted around a longitudinal axis of the extrudate and wherein the twisted lobes have a pitch from about 0.5 turns/inch (0.5 turns per 2.54 cm) to about 2 turns/inch (2 turns per 2.54 cm).

12. The method of claim 11, wherein the pitch is at least 0.5 turns/inch (0.5 turns per 2.54 cm) and less than about 2 turns/inch (2 turns per 2.54 cm).

13. The method of claim 11, wherein the pitch is at least 0.7 turns/inch (0.7 turns per 2.54 cm) and no more than 1.6 turns/inch (1.6 turns per 2.54 cm).

14. The method of claim 11, wherein a diameter of the apertures is from about 1/30 inch (0.8 mm) to about ⅛ inch (3.2 mm).

15. The method of claim 11, wherein the twisted polylobed extrudates formed at step (c) have an extruded length greater than about 2 inch (5.08 cm).

16. The method of claim 11, wherein the twisted polylobed extrudates comprise at least one of a zeolite or a mesoporous material, a binder and, optionally, a promoter.

17. Use of the twisted polylobed extrudate of claim 1 as a catalyst.

18. Use of the twisted polylobed extrudate of claim 1 as an adsorbent.
